(19) United States
(12) Patent Application Publication
(10) Pub. No.: US 2005/0021471 A1
(43) Pub. Date: Jan. 27, 2005

(54) File system with payment for access to resources

(75) Inventor: Aviad Zlotnick, D.N. Galil Takhton (IL)

Correspondence Address: Stephen C. Kaufman;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/624,663

(22) Filed: Jul. 22, 2003

(51) Int. Cl. G06F 17/60

(52) U.S. Cl. 705/52

(57) ABSTRACT

A method for managing a file system includes assigning a price to at least one resource of the file system. Upon receiving an application program interface (API) call from a user of the file system asking to access the at least one resource, the at least one resource is provided to the user in response to the API call while charging the user for use of the resource in accordance with the assigned price.

### FIELD OF THE INVENTION

The present invention relates generally to computer file systems, and specifically to methods for controlling and monitoring user access to file system resources.

### BACKGROUND OF THE INVENTION

A file system is a hierarchical collection of files and file directories that are stored on mass storage media, typically on disk, and are accessed using a predefined interface. The term “file system” is also used to denote file system software, i.e., the part of an operating system or an add-on program that supports a file system. The file system software typically includes application program interfaces (APIs) that enable user software applications to access resources in the file system, including specified files, directories and storage volumes. Common file system APIs include, for example, MOUNT( ) UNMOUNT( ) OPEN( ), CLOSE( ), READ( ) and WRITE( ). When invoked by a user, these APIs typically generate operating system kernel functions, which operate on the resources specified by the user in the API.

Distributed file systems allow a user on a client computer that is connected to a network to access and modify data stored in files on a file server. When a user accesses data on the file server, a copy of the data may be cached on the client computer, and the user can then read and, if permitted, modify the copy. When the user is finished, the modified data are written back to the file server. Examples of distributed file systems include Sun Microsystems' Network File System (NFS™), Novell Netware™ and the Andrew File System (AFS). Distributed file systems can also be used in accessing network-attached storage (NAS) devices—hard disk storage that is set up with its own network address, rather than being attached to a server that also serves applications to users on the network, as in classical client/server models.

### SUMMARY OF THE INVENTION

Embodiments of the present invention provide methods, servers and software that enable an owner or manager of a file system to charge users for access to file system resources. These embodiments are based on modifying the conventional file system APIs so as to allow a price to be assigned to each resource in the file system. From the point of view of the user (and of user software applications), however, the semantics and functionality of the APIs are unchanged.

When the user makes an API call to the file system, asking to access a certain resource, the file system software checks the price that has been assigned to the resource. The price may be uniform, or it may alternatively depend on the identity of the user, with different prices assigned to different users or classes of users. The price may be based on substantially any measure of use of the resource, such as duration of use, number of files opened or data volume transferred. The file system software tracks the cost accrued by the user, based on the assigned prices of the resources that the user accesses, and charges the user's account for the accrued cost. Optionally, at least a portion of an amount charged to the user may be credited automatically to suppliers of the resources.

There is therefore provided, in accordance with an embodiment of the present invention, a method for managing a file system, including:

assigning a price to at least one resource of the file system;

receiving an application program interface (API) call from a user of the file system asking to access the at least one resource; and

providing the at least one resource to the user while charging the user in response to the API call for use of the resource in accordance with the assigned price.

Typically, the at least one resource includes at least one of a file, a directory and a storage volume.

In one embodiment, assigning the price includes determining charges for use of files in the file system depending on a number of the files opened by the user. In another embodiment, assigning the price includes determining charges for use of the at least one resource depending on a volume of data transferred from the file system to the user. In a further embodiment, assigning the price includes determining charges for use of the at least one resource depending on a length of time during which the at least one resource is in use by the user.

In an aspect of the invention, assigning the price includes assigning different, respective prices for the at least one resource to different classes of users. Typically, receiving the API call includes determining an identity of the user responsively to the API call, and providing the at least one resource includes selecting one of the respective prices depending on the identity of the user.

Additionally or alternatively, assigning the price includes assigning different, respective prices to a plurality of different resources.

In exemplary embodiments, receiving the API call includes receiving an invocation of at least one of a mount API, an open API, a read API and a write API.

Optionally, the method includes crediting a supplier of the at least one resource with at least a portion of an amount charged to the user for use of the resource.

In a disclosed embodiment, receiving the API call includes receiving a request from a client computer, transmitted over a network to a storage node, to access the at least one resource held in storage by the storage node, and providing the at least one resource includes conveying the at least one resource from the storage node over the network to the client computer.

Typically, charging the user includes at least one of recording a charge against an account held by the user and receiving a transfer of payment from the user.

There is also provided, in accordance with an embodiment of the present invention, apparatus for managing a file system, including:

a storage device, which is arranged to store resources of the file system; and

a processor, which is arranged to record a price assigned to at least one resource among the resources stored on the storage device, and which is further arranged, upon receiving an application program interface (API) call from a user of the file system asking to access the at least one resource, to provide the at least one resource from the storage device to the user in response to the API call while charging the user for use of the resource in accordance with the assigned price.

In a disclosed embodiment, the apparatus includes a display, which is arranged to present a listing of the resources so as to enable an operator of the apparatus to assign the price to the at least one resource.

There is additionally provided, in accordance with an embodiment of the present invention, a computer software product, including a computer-readable medium in which program instructions are stored, which instructions, when read by a computer, cause the computer to maintain a record of a price that is assigned to at least one resource of a file system, and upon receiving an application program interface (API) call from a user of the file system asking to access the at least one resource, to provide the at least one resource to the user in response to the API call while charging the user for use of the resource in accordance with the assigned price.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for provision of file system resources, in accordance with an embodiment of the present invention;

FIG. 2 is a table that schematically represents a user interface screen that is used in assigning prices to file system resources, in accordance with an embodiment of the present invention; and

FIG. 3 is a flow chart that schematically illustrates a method for charging users for access to file system resources, in accordance with an embodiment of the present invention.

### DETAILED DESCRIPTION OF EMBODIMENTS

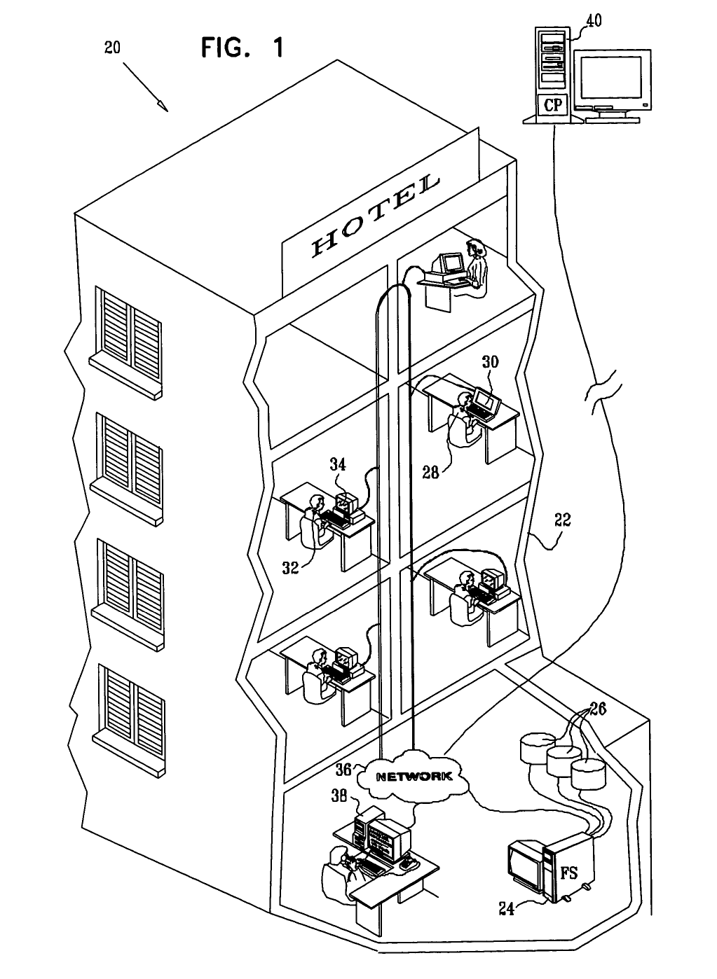

FIG. 1 is a schematic, pictorial illustration of a system 20 for provision of file system resources, in accordance with an embodiment of the present invention. In the present embodiment, system 20 is deployed in a facility 22, such as an office building or a hotel, in which multiple users 28, 32, . . . , access data resources held at a storage node. In the present example, the storage node comprises disks 26, which are accessed via a file server 24. This mode of deployment is shown and described here, however, solely by way of illustration. The principles of the present invention may similarly be implemented in substantially any file system, as will be apparent to those skilled in the art.

Users 28, 32, . . . , operate computer workstations 30, 34, . . . , which communicate with file server 24 via a network 36, such as a local area network (LAN). Each user is identified by a username, as is known in the art, which typically identifies not only the user himself/herself, but also the work group and/or organization to which the user belongs. For example, the username JOHN/HAIFA/IBM might identify user “John” as belonging to the Haifa facility of IBM Corporation. Alternatively, in the above-mentioned example in which facility 22 is a hotel, the username might identify the user's room number for purposes of accessing and being charged for hotel data services provided via network 36.

Server 24 maintains data resources on storage volumes 26, which typically comprise hard disks or other mass storage media. These data resources may comprise substantially any sort of content that may be of interest to users 28, 32, . . . . For example, storage volumes 26 may hold entertainment content, such as movies, music or game programs. Alternatively or additionally, the storage volumes may hold databases, text files or substantially any other type of information resources known in the art, as well as application programs. A file system on server 24 defines and identifies the volumes, directories and files in which the resources are held. Users 28, 32, access these resources by invoking file system APIs on their respective workstations 30, 34, . . . . From the point of view of the users and user software applications, the semantics of these APIs may be substantially identical to file system APIs known in the art.

The file system on server 24 includes metadata with respect to each resource held in storage volumes 26. In conventional file systems, these metadata include information such as the file name, directory path and access permissions, indicating which users are authorized to read a given resource and which, if any, are authorized to modify it. The file system on server 24 is extended, in accordance with the present invention, so that the metadata also include price information for some or all of the resources in the file system. When a user asks to access a resource via server 24 by invoking the appropriate API, the server looks up the corresponding price in the metadata, and then charges the user accordingly, in addition to performing the conventional file system functions called for by the API. The accounting of charges may be maintained internally by server 24 or reported to a separate billing server 38 (which charges the user's room account, in the hotel example described above). optionally, when a resource is provided by a third-party content provider 40, file server 24 may credit the content provider with a portion of the amount charged to users who access the resource. These functions of the file server are described in greater detail hereinbelow.

Typically, server 24 comprises a general-purpose computer processor, which is programmed in software to act as a file server and carry out the functions described herein. The software may be downloaded to the file server in electronic form, over a communication network, for example, or it may alternatively be provided on tangible media, such as CD-ROM. It is a feature of the present invention—although not a prerequisite—that the cost tracking functions described herein can be implemented by straightforward extensions to existing file system software, and without modification to the APIs used by workstations 30, 34, . . . , to access the file system. In a sense, these cost tracking functions can be seen as an extension of the access permission function provided by conventional file systems, except that instead of just applying different permission levels to different users (or classes of users), based on their usernames, the file system now applies different access prices to the different classes of users. Denying certain users permission to access a given resource is equivalent to assigning the resource an infinite price with respect to these users.

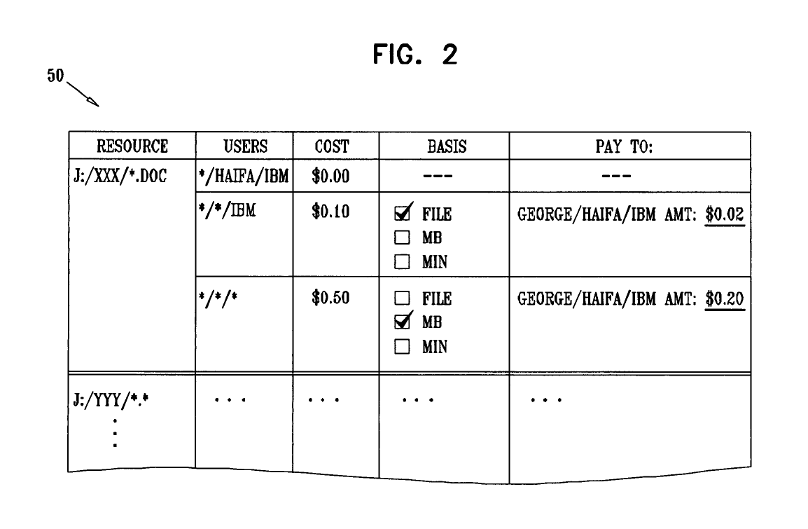

FIG. 2 is a table that schematically represents a user interface screen 50 displayed by server 24, which enables a file system manager to assign prices to different resources. In the example shown in the figure, the system manager chooses to assign a certain pricing scheme to all files with extension “doc” in directory “xxx” on volume J:. Alternatively or additionally, the manager may choose to apply an individual pricing scheme to certain specific files, or may apply a blanket pricing scheme to an entire directory (such as directory “yyy” in the lower row shown in the figure) or to a group of directories or an entire volume.

The prices assigned by the system manager are differentiated according to classes of users. The charge basis may also be differentiated. Thus, in the present example, users in the Haifa work group of IBM Corporation (*/HAIFA/IBM) are entitled to free access to the files in question, i.e., COST =$0.00. Users in other IBM work groups (*/*/IBM) are assigned a cost of $0.10 per file that they access. All other users are assigned a cost of $0.50 per Megabyte of data that they receive from server 24. Alternatively or additionally, other groups of users may be defined, as may other pricing bases, such as a charge based on the length of time during which a given volume is mounted or a given file is open.

In addition, screen 50 includes a “pay to” column, specifying that server 24 is to credit a provider of a certain resource with a portion of the amounts charged to users of the resource. In the present example, this column indicates that GEORGE/HAIFA/IBM is to receive $0.02 for each file “doc” file in directory J:/xxx that is used by an IBM user, and $0.20 for each Megabyte of data supplied from these files to other users. This mechanism may be used by the manager of the file system on server 24 to compensate third-party content providers, as noted above. In the present example, it may also be used by the file system owner (in this case IBM) to reward employees who develop useful content. As a further option, the file system on server 24 may allow users to set the prices for their own resources, in a manner similar to the way in which users may set access permissions for their own files in file systems known in the art. For example, users may set prices using a SAVE( ) API with appropriate extensions, or using a graphical interface similar to screen 50.

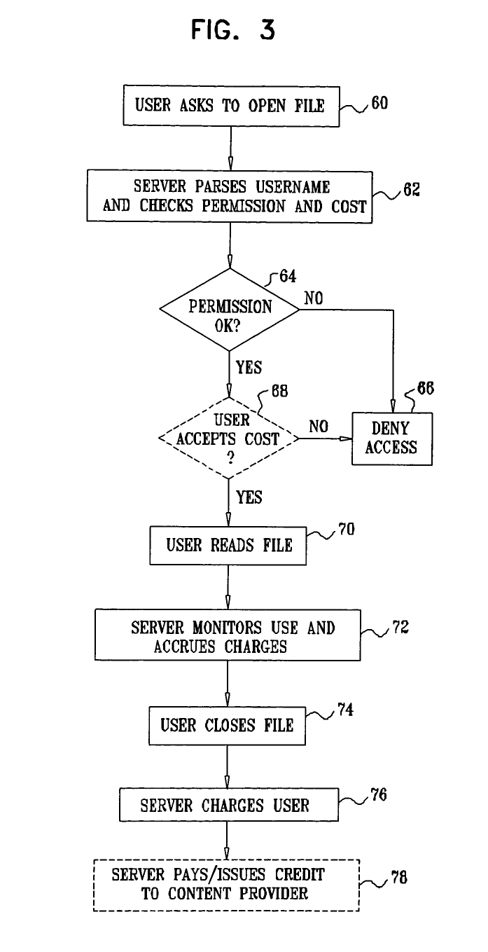

FIG. 3 is a flow chart that schematically illustrates a method for charging users for access to a file held in a file system, in accordance with an embodiment of the present invention. The process described here begins, for example, when user 28 of workstation 30 asks to open a particular file on server 24, at a file opening step 60. Prior to step 60, the user may be required to mount the volume on which the file is stored. As noted above, server 24 may additionally or alternatively charge the user for mounting the volume, and not only for accessing files. Details of these mounting functions are omitted here, however, for the sake of simplicity. The methods described hereinbelow with respect to charging users for opening and reading files may be extended in a straightforward way to MOUNT( ) and other file system APIs.

User 28 (or application software running on workstation 30) initiates step 60 by calling an appropriate file system API, such as OPEN(path/filename). This API causes workstation 30 to send a file request to server 24. The file request 'specifies the desired path and file and the username of the user requesting the file. Server 24 receives the file request and parses the username to determine the identity of the user and/or the work group or organization to which the user belongs, at a user identification step 62. The server checks this information against the metadata of the requested file. As noted above, the metadata indicate which users are permitted to access the file and if so, at what price.

The server checks the username against the permissions listed in the metadata for the requested file, at a permission checking step 64. If this user is not permitted to access the file, the server returns an access denial message to workstation 30, at an access denial step 66, as is known in the art. Optionally, the server also checks whether the user is willing and able to pay the specified cost for this file, at a price checking step 68. For example, if the cost of using the file is to be charged against a prepaid or credit account, the server may check that the there are sufficient funds or credit remaining in the account to pay for use of the file. Additionally or alternatively, the server may cause workstation 30 to display a message asking user 28 to approve the charge before opening the file. Further additionally or alternatively, when the user views a directory of files on the workstation display, the user may choose to see the prices assigned to each of the files. In any case, if the user is unwilling or unable to pay the price of the file he/she has requested, the OPEN( ) API exits at step 66, in the manner described above.

Assuming steps 64 and 68 are passed successfully, however, server 24 opens the requested file. Workstation 30 may then read data from the file, typically using a READ( ) API, at a file reading step 70. Depending on the price basis applicable to user 28, server 24 monitors use of the file, at a monitoring step 72. For example, the server may monitor the number of files, volume of data, or length of time during which files are in use, as illustrated by the different price bases listed in table 50. Based on the use of the file on workstation 30, the server accrues charges against the client's account, until the user closes the file, at a file closing step 74.

The server charges the user for the accrued charges, at a billing step 76. Substantially any suitable payment method known in the art may be used at this step. For instance, the charges may be billed to a customer account, which is paid periodically, as in telephone billing systems or in the hotel example described above. Alternatively, the charges may be paid immediately using a system of micro-payments or other payment medium to transfer credits over a network. Further alternatively, the charges may simply be recorded in the cost-accounting records of an organization, without any actual exchange of funds. When the file in question contains content supplied by an independent or in-house content provider, as described above, server 24 may also transfer a portion of the charges to the content provider, at a provider payment step 78. This transfer may likewise take the form of either periodic credit, immediate payment, or cost accounting.

Whereas in the embodiment described above, the user is charged in connection with invocation of the READ( ) API, server 24 may accrue charges based on other file and disk operations, as well. For example, server 24 may charge the user for use of disk space, based on the WRITE( ) API. The charge in this case could be based on the volume of data written to disk, or on the amount of disk space occupied by data in user files multiplied by the length of time during which the data remain on disk until they are erased. File systems typically have quotas on the amount of disk space allowed to each user, and server 24 may also charge users for the operation of setting the quota.

As noted above, file systems with payment for access to resources may be used in a wide variety of different applications, for example:

A hotel may collect popular content files, such as music, video and other entertainment content, and may allow guests to connect to the hotel LAN and access these files for a price. Permissions and prices of the files can be managed as part of the check-in process, with payment at check-out. Different pricing schemes may be applied to different rooms and classes of guests.

When two organizations, such as business corporations, enter into a partnering relationship, each organization may give the other one access to its intranet. Attaching appropriate prices to the resources on the intranet allows the organizations to build the partnership in such a way that their income and expenditures reflect their actual contributions to the partnership and the benefits they derive.

An enterprise or other organization can manage its Information Technology (IT) program by charging its own internal customers for their use of file system resources. The accrued charges for different resources indicate to the IT managers which resources are in high demand and which are superfluous. The IT department can thus concentrate its efforts and budget on the actual needs of the organization. The file system charges can also be used to measure employees' use of and contributions to the IT resources of the organization.

Although system 20 is built around a single, central file server 24 on a LAN 36, following the paradigm of distributed file systems, the principles of the present invention may be applied to substantially any sort of storage node, such as NAS devices and nodes in storage area networks (SANs), and to substantially any file system, including parallel file systems. Furthermore, the principles of the present invention are applicable not only to file systems that serve multiple users, as described above, but also to single-user file systems. In this latter case, the file system may track the use of resources on the local hard disk or optical storage media, for example, and may maintain an accounting record locally and/or transmit credits and debits via a network.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for managing a file system, comprising:
assigning a price to at least one resource of the file system;
receiving an application program interface (API) call from a user of the file system asking to access the at least one resource; and
providing the at least one resource to the user while charging the user in response to the API call for use of the resource in accordance with the assigned price.

2. The method according to claim 1, wherein the at least one resource comprises at least one of a file, a directory and a storage volume.

3. The method according to claim 1, wherein assigning the price comprises determining charges for use of files in the file system depending on a number of the files opened by the user.

4. The method according to claim 1, wherein assigning the price comprises determining charges for use of the at least one resource depending on a volume of data transferred from the file system to the user.

5. The method according to claim 1, wherein assigning the price comprises determining charges for use of the at least one resource depending on a length of time during which the at least one resource is in use by the user.

6. The method according to claim 1, wherein assigning the price comprises assigning different, respective prices for the at least one resource to different classes of users.

7. The method according to claim 6, wherein receiving the API call comprises determining an identity of the user responsively to the API call, and wherein providing the at least one resource comprises selecting one of the respective prices depending on the identity of the user.

8. The method according to claim 1, wherein assigning the price comprises assigning different, respective prices to a plurality of different resources.

9. The method according to claim 1, wherein receiving the API call comprises receiving an invocation of at least one of a mount API, an open API, a read API and a write API.

10. The method according to claim 1, and comprising crediting a supplier of the at least one resource with at least a portion of an amount charged to the user for use of the resource.

11. The method according to claim 1, wherein receiving the API call comprises receiving a request from a client computer, transmitted over a network to a storage node, to access the at least one resource held in storage by the storage node, and wherein providing the at least one resource comprises conveying the at least one resource from the storage node over the network to the client computer.

12. The method according to claim 1, wherein charging the user comprises at least one of recording a charge against an account held by the user and receiving a transfer of payment from the user.

13. The method according to claim 1, wherein assigning the price comprises displaying a listing of the resources so as to enable an operator of the apparatus to assign the price to the at least one resource.

14. Apparatus for managing a file system, comprising:
a storage device, which is arranged to store resources of the file system; and
a processor, which is arranged to record a price assigned to at least one resource among the resources stored on the storage device, and which is further arranged, upon receiving an application program interface (API) call from a user of the file system asking to access the at least one resource, to provide the at least one resource from the storage device to the user while charging the user in response to the API call for use of the resource in accordance with the assigned price.

15. The apparatus according to claim 14, wherein the at least one resource comprises at least one of a file, a directory and a storage volume.

16. The apparatus according to claim 14, wherein the processor is arranged, in accordance with the assigned price, to charge the user for use of files in the file system depending on a number of the files opened by the user.

17. The apparatus according to claim 14, wherein the processor is arranged, in accordance with the assigned price, to charge the user for use of the at least one resource depending on a volume of data transferred from the storage device to the user.

18. The apparatus according to claim 14, wherein the processor is arranged, in accordance with the assigned price, to charge the user for use of the at least one resource depending on a length of time during which the at least one resource is in use by the user.

19. The apparatus according to claim 14, wherein the processor is arranged, in accordance with the assigned price, to charge different, respective prices for the at least one resource to different classes of users.

20. The apparatus according to claim 19, wherein the processor is arranged to determine an identity of the user responsively to the API call, and to select one of the respective prices depending on the identity of the user.

21. The apparatus according to claim 14, wherein the processor is arranged, in accordance with the assigned price, to charge different, respective prices for different resources of the file system.

22. The apparatus according to claim 14, wherein the API call comprises at least one of a mount API, an open API, a read API and a write API.

23. The apparatus according to claim 14, wherein the processor is further arranged to credit a supplier of the at least one resource with at least a portion of an amount charged to the user for use of the resource.

24. The apparatus according to claim 14, wherein the processor is coupled to receive the API call over a network from a client computer, and to convey the at least one resource from the storage device over the network to the client computer.

25. The apparatus according to claim 14, wherein the processor is arranged to charge the user by performing at least one of recording a charge against an account held by the user and receiving a transfer of payment from the user.

26. The apparatus according to claim 14, and comprising a display, which is arranged to present a listing of the resources so as to enable an operator of the apparatus to assign the price to the at least one resource.

27. A computer software product, comprising a computer-readable medium in which program instructions are stored, which instructions, when read by a computer, cause the computer to maintain a record of a price that is assigned to at least one resource of a file system, and upon receiving an application program interface (API) call from a user of the file system asking to access the at least one resource, to provide the at least one resource to the user while charging the user in response to the API call for use of the resource in accordance with the assigned price.

28. The product according to claim 27, wherein the at least one resource comprises at least one of a file, a directory and a storage volume.

29. The product according to claim 27, wherein the instructions cause the computer, in accordance with the assigned price, to charge the user for use of files in the file system depending on a number of the files opened by the user.

30. The product according to claim 27, wherein the instructions cause the computer, in accordance with the assigned price, to charge the user for use of the at least one resource depending on a volume of data transferred to the user.

31. The product according to claim 27, wherein the instructions cause the computer, in accordance with the assigned price, to charge the user for use of the at least one resource depending on a length of time during which the at least one resource is in use by the user.

32. The product according to claim 27, wherein the instructions cause the computer, in accordance with the assigned price, to charge different, respective prices for the at least one resource to different classes of users.

33. The product according to claim 30, wherein the instructions cause the computer to determine an identity of the user responsively to the API call, and to select one of the respective prices depending on the identity of the user.

34. The product according to claim 27, wherein the instructions cause the computer, in accordance with the assigned price, to charge different, respective prices for different resources of the file system.

35. The product according to claim 27, wherein the API call comprises at least one of a mount API, an open API, a read API and a write API.

36. The product according to claim 27, wherein the instructions further cause the computer to credit a supplier of the at least one resource with at least a portion of an amount charged to the user for use of the resource.

37. The product according to claim 27, wherein the computer is coupled to receive the API call over a network from a client computer, and wherein the instructions cause the computer to convey the at least one resource from the storage device over the network to the client computer.

38. The product according to claim 27, wherein the instructions cause the computer to charge the user by performing at least one of recording a charge against an account held by the user and receiving a transfer of payment from the user.

39. The product according to claim 27, wherein the instructions cause the computer to display a listing of the resources so as to enable an operator of the apparatus to assign the price to the at least one resource.
